(19) United States
(12) Patent Application Publication
(10) Pub. No.: US 2026/0288815 A1
(43) Pub. Date: Sep. 24, 2026

(54) NON-TRANSITORY COMPUTER READABLE MEDIUM FOR RESPONSE TIME MANAGEMENT PROGRAM, RESPONSE TIME MANAGEMENT APPARATUS, AND CHAT SYSTEM

(71) Applicant: Honda Motor Co., Ltd., Tokyo (JP)

(72) Inventors: Tameaki Honda, Tokyo (JP); Yosuke Fuchiwaki, Tokyo (JP); Hiroshi Honda, Tokyo (JP); Kazuki Yoshigai, Tokyo (JP)

(21) Appl. No.: 19/567,097

(22) Filed: Mar. 14, 2026

(30) Foreign Application Priority Data
Mar. 19, 2025 (JP) 2025-044445

(51) Int. Cl. G06F 16/3329

(52) U.S. Cl. CPC G06F 16/33295

(57) ABSTRACT

A response time management program causes a computer to perform: detecting an elapsed time from when an operator terminal receives question information from a user terminal until answer information is sent to the user terminal; determining a reference response time which is a reference value of a time from when the operator terminal receives the question information from the user terminal until the answer information is sent to the user terminal, based on an information amount of the answer information sent from the operator terminal to the user terminal; and when it is detected that the operator has performed an operation to send the answer information to the user terminal before the elapsed time reaches the reference response time, temporarily holding a sending of the answer information, and sending the answer information after the reference response time is reached.

### CROSS-REFERENCE TO RELATED APPLICATION

This application is based upon and claims the benefit of priority from Japanese Patent Application No. 2025-044445 filed on March 19, 2025, the content of which is incorporated herein by reference.

### BACKGROUND

### Technical Field

The present disclosure relates to a non-transitory computer readable medium for response time management program, a response time management apparatus, and a chat system suitable for use together with a manned chat service.

### Related Art

A system that receives an input from a user on a communication terminal and outputs a response to the input via a network is known. JP 2019-159880 A discloses a technique in which a response device outputs a response to a character string input from a user via a communication terminal. The response device receives a character string input by the user, and executes a first response process to determine an answer to the received character string. At this time, the sub-processing unit executes a second response process in parallel with the first response process, and determines an answer to the received character string. Then, an answer suitable for the user can be obtained by outputting the answer of the first response process and outputting the answer of the second response process in addition to the answer of the first response process in a case where the information regarding the user satisfies a predetermined condition.

In a manned chat service, a manned operator who receives a question from a user needs to respond to a wide variety of questions from various users. Therefore, the manned operator can utilize the generative AI system when obtaining necessary information for returning to the user. By using the generative AI system, a lot of information can be obtained in a relatively short time. However, if the manned operator returns a lot of information to the user in too short a time, the user feels as if he/she has received a response from the unmanned system, and there is a possibility that the customer satisfaction is lowered. This can also occur when the manned operator immediately transmits a lot of information to the user in response to the questions received from the user because the manned operator had abundant knowledge.

### SUMMARY

An aspect of the present invention is a computer-readable storage medium storing a response time management program for causing a computer comprising a processor and a storage unit to perform processing. The response time management program is configured to manage a time from when question information sent by a customer operating a user terminal is received at an operator terminal operated by an operator, until the operator accesses an information source to obtain answer information corresponding to the question information, creates the answer information based on an original answer, and performs an operation to send the answer information from the operator terminal to the user terminal, the original answer is information obtained from the information source, and the response time management program causes the computer to perform: detecting an elapsed time from when the operator terminal receives the question information from the user terminal until the answer information is sent to the user terminal; determining a reference response time based on an answer information amount, the answer information amount being an information amount of the answer information sent from the operator terminal to the user terminal, the reference response time being a reference value of a time from when the operator terminal receives the question information from the user terminal until the answer information is sent to the user terminal; and when it is detected that the operator has performed an operation to send the answer information to the user terminal before the elapsed time reaches the reference response time, temporarily holding a sending of the answer information, and sending the answer information after the reference response time is reached.

Another aspect of the present invention is a response time management apparatus configured to manage a time from when question information sent by a customer operating a user terminal is received at an operator terminal operated by an operator, until the operator accesses an information source to obtain answer information corresponding to the question information, creates the answer information based on an original answer, and performs an operation to send the answer information from the operator terminal to the user terminal, the original answer being information obtained from the information source, the response time management apparatus comprising a microprocessor and a memory connected to the microprocessor. The microprocessor is configured to perform: detecting an elapsed time from when the operator terminal receives the question information from the user terminal until the answer information is sent to the user terminal; determining a reference response time that is a reference value of the time from when the operator terminal receives the question information from the user terminal until the answer information is sent to the user terminal, based on an answer information amount that is an information amount of the answer information sent from the operator terminal to the user terminal; and when it is detected that the operator has performed an operation to send the answer information to the user terminal before the elapsed time reaches the reference response time, temporarily holding the sending of the answer information to the user terminal, and sending the answer information after the reference response time is reached.

Still another aspect of the present invention is a chat system comprising:

a user terminal operated by a customer; an operator terminal operated by an operator; and a response time management apparatus configured to manage a time from when question information sent by the customer operating the user terminal is received at the operator terminal, until the operator accesses an information source to obtain answer information corresponding to the question information, creates the answer information based on an original answer, and sends the answer information from the operator terminal to the user terminal. The original answer is information obtained from the information source, the response time management apparatus comprises a microprocessor and a memory connected to the microprocessor, and the microprocessor is configured to perform: detecting an elapsed time from when the operator terminal receives the question information from the user terminal until the answer information is sent to the user terminal; determining a reference response time that is a reference value of the time from when the operator terminal receives the question information from the user terminal until the answer information is sent to the user terminal, based on an answer information amount that is an information amount of the answer information sent from the operator terminal to the user terminal; and when it is detected that the operator has performed an operation to send the answer information to the user terminal before the elapsed time reaches the reference response time, temporarily holding the sending of the answer information, and sending the answer information after the reference response time is reached.

### BRIEF DESCRIPTION OF THE DRAWINGS

The objects, features, and advantages of the present invention will become clearer from the following description of embodiments in relation to the attached drawings, in which:

FIG. 1 is a conceptual diagram illustrating a schematic configuration of a manned chat system;

FIG. 2 is a block diagram illustrating the functional blocks of a computer constituting a response time management apparatus and components connected to the response time management apparatus via a network;

FIG. 3 is a flowchart illustrating a schematic processing procedure of response time management processing executed by a CPU of the response time management apparatus; and

FIG. 4 is a flowchart illustrating another example of the schematic processing procedure of response time management processing executed by the CPU of the response time management apparatus.

### DETAILED DESCRIPTION

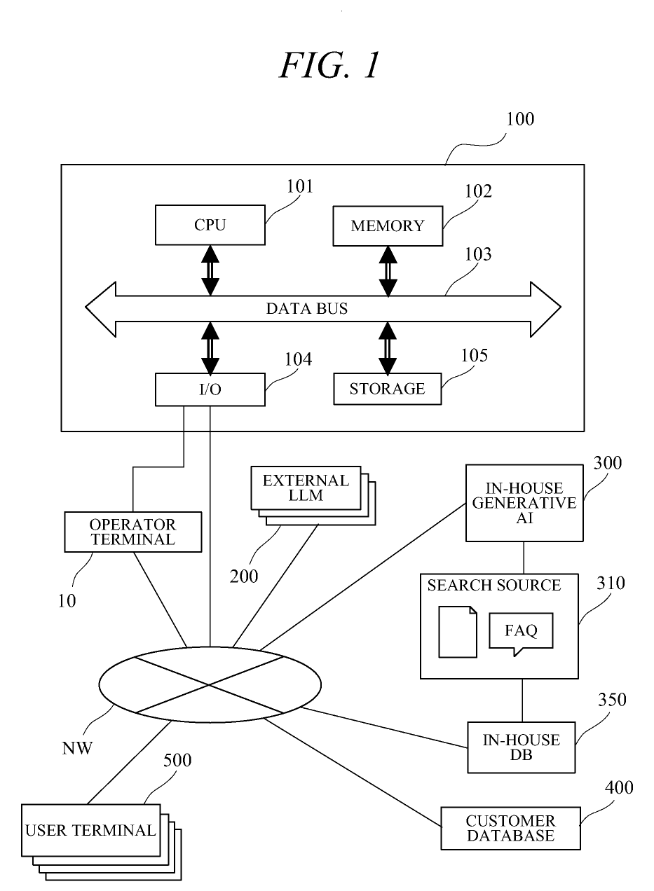

Hereinafter, an embodiment of the present disclosure will be described with reference to FIGS. 1 to 4. In all the drawings described below, common components are denoted by the same reference numerals, and repeated description is omitted. Note that not all the components shown in the following embodiments are essential components of the present disclosure.

FIG. 1 is a conceptual diagram for explaining a schematic configuration of a manned chat system. An operator terminal 10 operated by an operator of a manned chat (hereinafter simply referred to as an operator) is connected to an external LLM 200, an in-house generative AI system 300, an in-house database (In-house DB) 350, a customer database 400, and a user terminal 500 via a network NW. A server 100 constituting a response time management apparatus is connected to both the operator terminal 10 and the network NW. The server 100 and the operator terminal 10 may be connected via the network NW without being directly connected. Further, a response time management function of the server 100 described below may be included in the operator terminal 10. A common search source 310 is connected to the in-house generative AI system 300 and the in-house database 350. Instead of connecting the in-house generative AI system 300 and the in-house database 350 to the common search source 310, each of the in-house generative AI system 300 and the in-house database 350 may be connected to separate search sources.

The external LLM 200 can be, for example, a Large Language Model (LLM) provided by a third party. The LLM is a large scale artificial intelligence model constructed by using a large set of text data and deep learning technologies, and used in the field of natural language processing (NLP). The LLM can learn a large amount of text data (web pages, books, articles, and the like) to understand patterns of languages used by humans and effectively perform natural language generation (NLG) tasks.

Hereinafter, the use of the LLM as an external source when providing a manned chat service to a user will be described as an example, but another external service utilizing AI, such as ChatGPT, Google Gemini (registered trademark), Cerence (registered trademark), or Claude3 (registered trademark), may be used. Furthermore, depending on the performance required for the manned chat, another natural language processing including a small language model (SLM) may be used.

The in-house generative AI system 300 is a system which accumulates and constructs information of a company, which provides a manned chat service, as the search source 310, abundantly includes documents such as products and services sold, provided, or the like by the company and an operation manual accompanying the same, and information or the like regarding a frequently asked question (FAQ) in the past, and can increase accuracy of an answer generated by AI and reduce hallucination.

Furthermore, it is possible not only to output a general answer to a question sent from the user who is driving the vehicle, but also to output a more specific response such as "Please press the switch with a green design on the lower left among the plurality of steering switches provided on the right steering spoke".

Furthermore, when receiving a question about a product such as a vehicle provided by the company or a service of an electronic commerce (EC) site or the like which is a website that sells a product or a service on the Internet, it is possible to output more detailed and diverse information to the user.

In addition, since the system is a company’s system, it is advantageous in that an increase in cost can be suppressed even in a case where a transaction when the operator interacts with AI increases during execution of a manned chat session.

The customer database 400 is a database in which login information such as a password is accumulated in association with a user ID input when the user logs in to the manned chat service.

The user terminal 500 is an information processing device operated by a user who uses a manned chat service provided by being connected to the operator terminal 10. For example, a smartphone, a tablet terminal, a personal digital assistant (PDA), a personal computer, or the like can be used as the user terminal 500. Furthermore, an in-vehicle infotainment (IVI) device connected to the network NW via a wireless communication network can be used as the user terminal 500.

The network NW can use the Internet. Note that the in-house generative AI system 300, the customer database 400, and the server 100 may be connected via a closed network service not via the Internet, or may be connected using a VPN technology. Alternatively, the in-house generative AI system 300 and the customer database 400 may be included in the server 100. It is desirable to protect the customer database 400 using a strong encryption technology in order to enhance information security.

When the customer operates the user terminal 500, the question information is transmitted from the user terminal 500 to the operator terminal 10 operated by the operator. In response to the question information being received by the operator terminal 10, the operator accesses any one or more of the external LLM 200, the in-house generative AI system 300, and the in-house database 350 as necessary to obtain an answer corresponding to the question information issued from the customer. Hereinafter, any one or more of the external LLM 200, the in-house generative AI system 300, and the in-house database 350 accessed by the operator may be simply referred to as an information source. In addition, an answer obtained from an information source may be referred to as an original answer. The operator creates answer information to be sent to the customer based on the original answer, and performs an operation to output the answer information to the user terminal 500 that is a source of the question information.

The response between the customer and the operator will be described in more detail. The operator looks at the question information transmitted from the user terminal 500 to the operator terminal 10, communicates with the customer via the operator terminal 10 and the user terminal 500 as necessary, and can check and organize the intention of the question sent from the customer and the gist of the question. In a case where the operator determines that it is possible to answer the question sent from the customer to the customer without accessing the above-described information source, the operator can prepare answer information by operating the operator terminal 10.

On the other hand, in a case where it is determined that it is necessary to access the information source, the operator operates the operator terminal 10, prepares a prompt that is a question sentence for the external LLM 200 or the in-house generative AI system 300, and outputs the prompt to the information source, or prepares a search command for the in-house database 350, and outputs the search command to the information source. From the information source accessed by the operator, the operator obtains the original answer corresponding to the above prompt or search command. The operator creates answer information by performing processing such as editing on the original answer as necessary. When it is determined that processing of the original answer is unnecessary, the operator can use the original answer as answer information. The operator uses the operator terminal 10 to perform an operation of sending out answer information to the user terminal 500 that is a transmission source of the question information.

Depending on a wide variety of categories of questions sent from customers and complexity of question contents, it may take a long time to answer questions performed between the customer and the operator. On the other hand, when an information source such as the external LLM 200 or the in-house generative AI system 300 is accessed, even if the question content from the customer is complicated and diverse, a large amount of answer information corresponding to the question content may be sent to the user terminal 500 in a short time. Hereinafter, an elapsed time from when the question information is output from the user terminal 500 to when the operator operates the operator terminal 10 to send out the answer information to the question information is referred to as a response time. In order to manage the response time in the manned chat service, the server 100 functions as a response time management apparatus.

The server 100 includes a CPU 101, a memory 102, an I/O 104, a storage 105, and a data bus 103 that enables data exchange between these elements.

A response time management program for managing the response time may be stored in, for example, the storage 105, read from the storage 105 when the server 100 is activated, loaded into the memory 102, and executed by the CPU 101. Alternatively, the memory 102 may include a ROM, a flash memory, or the like, and a manned chat program stored in the ROM or the flash memory may be loaded into the memory 102 and executed by the CPU 101. In addition, a program obtained by being read from an optical disk drive device or a card reader (not illustrated) or being downloaded via the network NW may be loaded into the memory 102 and executed by the CPU 101.

Note that the server 100 can be virtually realized by providing all or a part of each hardware configuration in a distributed manner in a plurality of computers and connecting them to each other via the network NW. As described above, the server 100 is a concept including not only a server housed in a single housing or case but also a virtualized computer system.

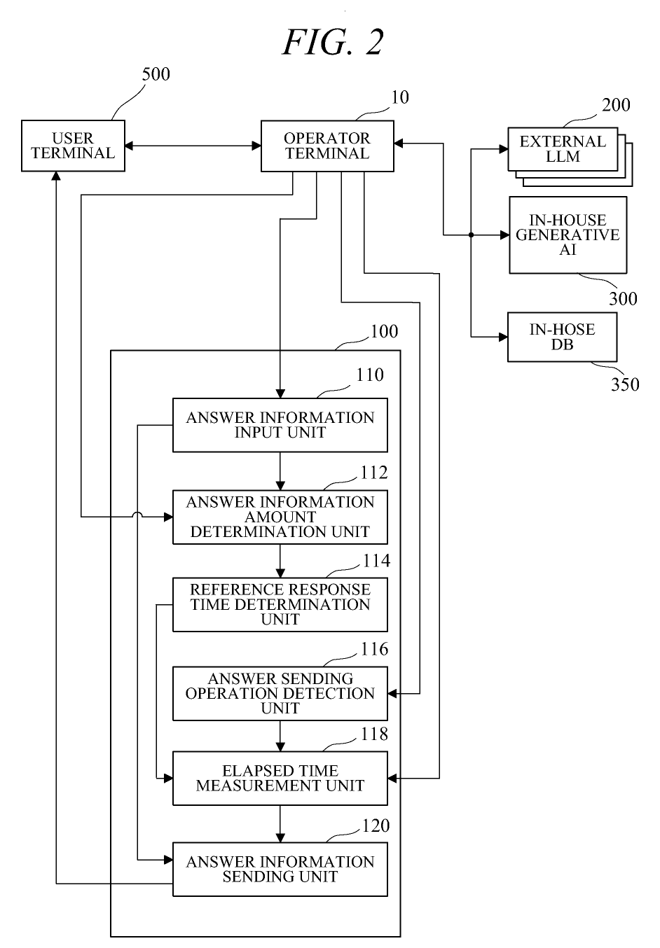

FIG. 2 is a block diagram for explaining a response time management apparatus realized by the CPU 101 of the server 100 executing a response time management program, and is a diagram illustrating other elements connected to the server 100 via the network NW.

As described above, based on the question information sent to the operator terminal 10 via the user terminal 500, the operator accesses any one or more of the external LLM 200, the in-house generative AI system 300, and the in-house database 350, that is, the information source to obtain the original answer. Then, processing such as editing is performed on the original answer as necessary to create answer information. The operator operates the operator terminal 10 to send the answer information to the user terminal 500 that has sent the question information. An answer information input unit 110 inputs and temporarily stores the answer information sent from the operator terminal 10.

An answer information amount determination unit 112 determines the answer information amount based on the amount of answer information input to the answer information input unit 110. The answer information amount determination unit 112 can determine the answer information amount based on, for example, the amount of sentences of the answer information and the number of main points (points) included in the answer. Instead of or in addition to the above, the answer information amount determination unit 112 is configured to analyze the question information sent from the user terminal 500 to the operator terminal 10 and determine the amount of information of the answer information corresponding to the question information.

A reference response time determination unit 114 determines a reference response time based on the determination result of the answer information amount by the answer information amount determination unit 112. Here, the reference response time is a time determined according to an information amount of answer information transmitted from the operator terminal 10 to the user terminal 500 that is a transmission source of the question information. For example, if a customer utters a question and an answer sent to the question has a small amount of information, the customer is less likely to feel uncomfortable even if the answer is close to an immediate answer. On the other hand, if the answer is close to an immediate answer even though the amount of information of the answer to the question uttered by the customer is large, there is a possibility that the customer is caught by the feeling as if the customer is responding to the question with the machine even though the customer and the operator are performing a manned chat, and there is a possibility that customer satisfaction will be lowered.

Therefore, the reference response time determination unit 114 is configured to determine the reference response time so that the reference response time increases as the answer information amount increases. The relationship between the answer information amount and the reference response time may have a linear relationship or a non-linear relationship. By setting the reference response time to be longer in a case where the answer information amount is large, as described below, it is possible to reduce a sense of discomfort felt by a customer who uses a manned chat because the response time is shorter than the amount of answer information, and to enhance customer satisfaction.

An answer sending operation detection unit 116 detects that the operator has operated the operator terminal 10 to send the answer information to the user terminal 500. An elapsed time measurement unit 118 measures and manages an elapsed time (hereinafter, referred to as an elapsed time after acceptance of a question) from when the question information is output to the operator terminal 10 via the user terminal 500 operated by the customer. Specifically, the elapsed time measurement unit 118 monitors the elapsed time after the acceptance of the question starting from the time point at which the question information is output to the operator terminal 10 via the user terminal 500, and determines whether the reference response time determined by the reference response time determination unit 114 has been reached. Then, when it is determined that the elapsed time after the acceptance of the question has reached the reference response time, the elapsed time measurement unit 118 issues a command to send answer information to an answer information sending unit 120.

The answer information sending unit 120 receives a command to send answer information from the elapsed time measurement unit 118, and sends the answer information temporarily stored in the answer information input unit 110 to the user terminal 500 that has sent the question information to the operator terminal 10.

By the way, in a case where the question information sent from the user terminal 500 is complicated, a case where the number of points to be answered is large, or the like, it is assumed that a long time is required until the operator finishes preparing the answer information. In such a case, the elapsed time measurement unit 118 is also configured to be able to monitor the elapsed time after the acceptance of the question regardless of the reference response time determined by the reference response time determination unit 114, and to send a message to the effect of "We are preparing the answer, but it takes time. Please wait a little more." to the user terminal 500 when a predetermined time has elapsed since the question information has been sent from the user terminal 500 to the operator terminal 10. The predetermined time can be 15 seconds, 20 seconds, or 30 seconds.

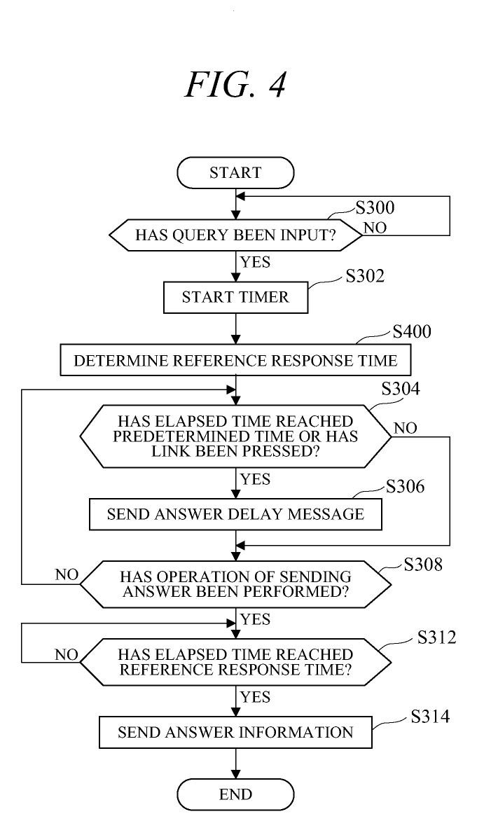

It has been described above that the answer information amount determination unit 112 may be configured to analyze the question information sent from the user terminal 500 to the operator terminal 10 and determine the answer information amount of the answer information corresponding to the question information. With this configuration, when the question information is sent from the user terminal 500 to the operator terminal 10, the remaining time until the answer information is sent from the operator terminal 10 to the user terminal 500 can be estimated. Therefore, it is also possible to send the expectation of the remaining waiting time to the user terminal 500 according to the detection situation of the elapsed time after the acceptance of the question by the elapsed time measurement unit 118. This will be described with reference to FIG. 4.

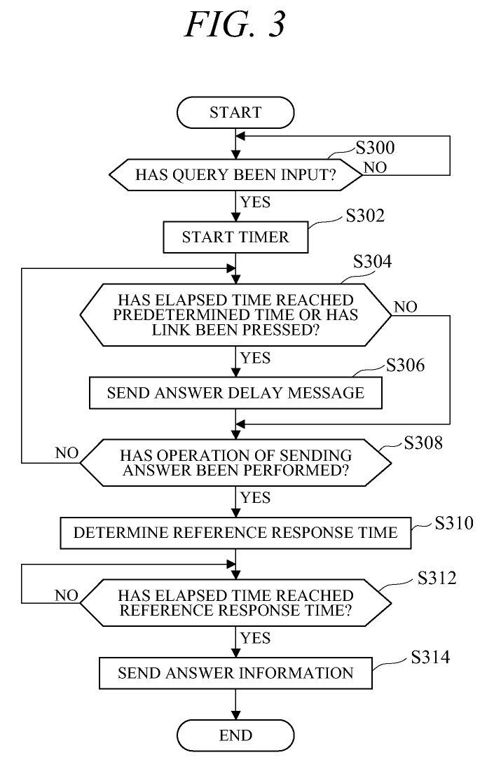

FIG. 3 is a flowchart illustrating a schematic processing procedure of response time management processing executed by the CPU 101 of the server 100. When the user terminal 500 operated by the customer and the operator terminal 10 operated by the operator are connected and a manned chat session is started, the response time management processing is started. In a case where the answer is repeatedly performed a plurality of times in one manned chat session, the process illustrated in FIG. 3 can be repeatedly executed. Note that prior to the process illustrated in FIG. 3, login operation by the customer or user authentication by the server 100 is performed as necessary, and a manned chat session is started.

In S300, the CPU 101 determines whether the question information has been sent from the user terminal 500 operated by the customer to the operator terminal 10, and repeats the process of S300 while this determination is denied. When it is detected that the question information has been sent from the user terminal 500 to the operator terminal 10, the process proceeds to S302, and the CPU 101 starts the timer and starts to measure the elapsed time after the acceptance of the question.

In S304, the CPU 101 determines whether the elapsed time after the acceptance of the question has reached a predetermined time, and when the determination in S304 is affirmative, the process proceeds to S306, and an answer delay message is sent to the user terminal 500 that has sent the question information. The answer delay message can be, for example, "We are preparing to answer the question you asked. Please wait a moment." The predetermined time described above can be 15 seconds, 20 seconds, or 30 seconds. By repeatedly performing the processes of S304 and S306 while a question from the user is complicated or the number of points to be answered is large and it takes time for the operator to prepare the answer information, the customer can recognize that the answer is being prepared.

An example in which, when it is determined in S304 that the elapsed time after the acceptance of the question has reached the predetermined time, an answer delay message is sent in S306 has been described above, but the following may be performed instead of or in addition to this. That is, it is assumed that the operator accesses information sources such as the external LLM 200, the in-house generative AI 300, and the in-house database 350 in order to prepare answer information, and a link is embedded in the obtained original answer. In a case where the CPU 101 detects that the operator has pressed the link in S304, the above-described answer delay message may be sent to the user terminal 500 in S306. The operator presses the link because it takes more time to prepare the answer information. Further, not only when the link is pressed, but also when the CPU 101 detects in S304 that the operator who has obtained the original answer has performed the further information search operation, an answer delay message can be sent to the user terminal 500 in S306.

In S308, the CPU 101 determines whether the operator has performed an operation of sending the answer information from the operator terminal 10 to the user terminal 500, and when this determination is negative, the process returns to S304. When the determination in S308 is affirmative, the process proceeds to S310, and the reference response time is determined based on the information amount of the answer information sent by the operator operating the operator terminal 10. Note that the answer information is temporarily stored in the server 100 without being immediately sent to the user terminal 500.

In S312, the CPU 101 determines whether the elapsed time after the acceptance of the question has reached the reference response time, and repeats the determination operation in S312 while the determination is negative. When the determination in S312 is affirmative, the CPU 101 sends the answer information to the user terminal 500 in S314.

According to the response time management processing of FIG. 3, when the customer obtains the answer information from the operator through the manned chat, the response is performed in the response time corresponding to the information amount of the answer information, so that it is possible to suppress impairment of the sense of responding as a person and to increase the satisfaction level of the customer who uses the manned chat. In addition, in a case where it takes time to prepare to send out the answer information, it is possible to suppress a situation in which the customer misunderstands that the waiting time is long and the chat session is interrupted and leaves the session, or a situation in which the customer is annoyed by a long silence, and it is possible to increase the satisfaction level of the customer.

Another example of the time management processing according to the present invention will be described with reference to FIG. 4. In each processing step illustrated in FIG. 4, the same components as those in the processing step illustrated in FIG. 3 are denoted by the same reference numerals, description thereof is omitted, and differences from the processing illustrated in FIG. 3 will be mainly described. The processing procedure illustrated in FIG. 4 is different from the processing procedure illustrated in FIG. 3 in that the reference response time determination processing in S310 illustrated in the processing procedure illustrated in FIG. 3 is performed as S400 between S302 and S304. Then, the answer information amount determination unit 112 is configured to analyze the question information when the question information is sent from the user terminal 500 to the operator terminal 10, and determine the answer information amount of the answer information corresponding to the question information.

After the question information is sent from the user terminal 500 operated by the customer to the operator terminal 10 operated by the operator, the determination in S300 is affirmed, and the counting of the elapsed time after the acceptance of the question starts in S302, the CPU 101 determines the reference response time in S400. That is, based on the question information sent from the user terminal 500 to the operator terminal 10, the reference response time is determined by estimating the remaining time until the answer information is sent from the operator terminal 10 to the user terminal 500.

In S304, the CPU 101 determines whether the elapsed time after the acceptance of the question has reached a predetermined time, and when the determination in S304 is affirmative, the process proceeds to S306, and an answer delay message is sent to the user terminal 500 that has sent the question information. At this time, the remaining time until the answer information is sent from the operator terminal 10 to the user terminal 500 can be predicted based on the reference response time and the elapsed time after the acceptance of the question described above. Therefore, an example of the answer delay message can be "We are now preparing to answer your question. We expect to be able to answer in about 30 seconds." Alternatively, instead of or in addition to the above, a graphical display such as a bar graph or an hourglass reminding of the remaining waiting time may be displayed on the display screen of the user terminal 500, and the bar graph may be shortened or the sand in the hourglass may fall from the top to the bottom as time elapses and approaches the reference response time. Furthermore, a sound that makes the user feel that the remaining waiting time is shortened may be emitted via a speaker or the like of the user terminal 500.

In S308, the CPU 101 determines whether the operator has performed an operation of sending the answer information from the operator terminal 10 to the user terminal 500, and when this determination is negative, the process returns to S304, which is the same as the example illustrated in FIG. 3. When the determination in S308 is affirmative, the process proceeds to S312, and the CPU 101 determines whether the elapsed time after the acceptance of the question has reached the reference response time, and repeats the determination operation in S312 while the determination is negative. When the determination in S312 is affirmative, the CPU 101 sends the answer information to the user terminal 500 in S314.

During the processing of the response time management illustrated in FIG. 4, when the operator prepares answer information, it can be detected in S304 that a link is embedded in the obtained original answer and the operator has pressed the link. In this case, an answer delay message can be sent to the user terminal 500 in S306. That is, in a case where the operator needs to collect new information and the time required to prepare the answer information is longer than expected, a message notifying the fact may be sent to the user terminal 500. In the determination as to whether the elapsed time after the acceptance of the question has reached the predetermined time and the determination as to whether the operator has pressed the link as described above in S304, either one of the determinations may be selectively performed, or both determinations may be performed.

In the flowchart of FIG. 4, S310 in the flowchart of FIG. 3 is omitted, but the process of S310 need not be omitted. In this way, in a case where the reference response time is determined in S400 based on the question information output from the user terminal 500, but the information amount of the answer information sent from the operator terminal 10 is different from that predicted when the reference response time is determined in S400, the reference response time can be corrected. As a result, when the answer information is sent to the user terminal 500 in S314, a message such as "This enabled us to respond earlier than expected." or "It took longer than expected to answer. Sorry." can be added.

According to the response time management processing described with reference to FIG. 4, when the customer obtains the answer information from the operator through the manned chat, in addition to that the response is performed in the response time corresponding to the information amount of the answer information, it is possible to suppress impairment of the sense of responding as a person and to increase the satisfaction level of the customer who uses the manned chat. In addition, in a case where it takes time to prepare to send out the answer information, it is possible to notify the customer of the estimated time until the answer information is sent out. Therefore, it is possible to suppress a situation in which the customer misunderstands that the waiting time is long and the chatbot session is interrupted and leaves the session, or a situation in which the customer is annoyed by a long silence, and it is possible to increase the satisfaction level of the customer.

In the above description with reference to FIG. 4, an example has been described in which the CPU 101 determines the reference response time by estimating the remaining time until the answer information is sent from the operator terminal 10 to the user terminal 500 in S400 based on the question information sent from the user terminal 500 to the operator terminal 10. Alternatively or in addition to this example, the reference response time can also be determined as follows. That is, the reference response time can be adjusted depending on whether the user has a personality who tends to be in a hurry or a personality who is gentle.

Regarding the waiting time from when the user operates the user terminal 500 to issue the question information to when the answer information is obtained, the reference response time can be set to be short for a user who wants the waiting time to be as short as possible. Alternatively, the reference response time can be intentionally set longer for a user who has a gentle personality and does not care about the waiting time. For example, the CPU 101 can acquire answer rapidity preference information capable of specifying sensitivity with respect to the length of the waiting time until the answer information is obtained after the user operates the user terminal 500 to utter the question information, and adjust the reference response time based on the answer rapidity information.

As a method of acquiring the answer rapidity preference information, for example, the answer rapidity preference information is accumulated in the customer database 400 (FIG. 1), and the answer rapidity preference information can be read out corresponding to the user specified based on the login information when the manned chat service is used. The answer rapidity preference information can be input by the customer himself/herself when the user registers the user prior to using the manned chat service. For example, it is possible to set and accumulate the answer rapidity preference information based on an answer from the user to a question such as "Do you like a short waiting time from when you asked a question to when there is an answer?".

Alternatively, at the start of a session of the chat service, or at an appropriate timing during the session, for example, after the user utters question information, a question such as "Do you want a short waiting time from when you ask a question to when an answer is given?" may be uttered to the customer, and the answer rapidity preference information may be set based on an answer from the user. With this setting, in a case where the user who usually likes a slow pace of answer has a question indicating that an abnormality has been detected during traveling in an urgent situation, for example, a vehicle driven by the user, the answer rapidity preference information can be set so as to shorten the response time. Furthermore, when the operator receives a question from the customer, the urgency is determined from the sentence of the question if the question is text-based, or from the tone of voice of the customer or the content of the question if the question is by voice, and the operator can set the answer rapidity preference information. Furthermore, information including the content of exchange performed between the user terminal 500 and the operator terminal 10 may be sent to the external LLM 200 or the in-house generative AI system 300, whether the customer desires an answer in a short time may be determined by the external LLM 200 or the in-house generative AI system 300, and the CPU 101 may set the answer rapidity preference information based on the determination result.

According to the present embodiment, the following operations and effects are achievable.

(1) A response time management program manages a time until the operator accesses the information source 200, 300, 350 to obtain answer information corresponding to the question information in response to the question information sent by the customer operating the user terminal 500 from the user terminal 500 (FIG. 2) operated by the customer being received by the operator terminal 10 operated by the operator, creates the answer information based on the original answer which is the information obtained from the information source 200, 300, 350, and performs an operation of sending the answer information from the operator terminal 10 to the user terminal 500. The response time management program causes the computer 100 (FIG. 2) to execute detecting an elapsed time from when the operator terminal 10 receives the question information from the user terminal 500 to when the answer information is sent to the user terminal 500 (S312 in FIG. 3), determining a reference response time which is a reference value of time from when the operator terminal 10 receives the question information from the user terminal 500 to when the answer information is sent to the user terminal 500 based on the answer information amount which is an information amount of the answer information sent from the operator terminal 10 to the user terminal 500 (S310 in FIG. 3), and when it is detected that the operator has performed an operation of sending the answer information to the user terminal before the elapsed time reaches the reference response time (S308 in FIG. 3: Yes), temporarily suspending sending of the answer information and sending the answer information after the reference response time has been reached (S314 in FIG. 3).

According to this, when the customer obtains the answer information from the operator through the manned chat, the response is performed in the response time corresponding to the information amount of the answer information, so that it is possible to suppress impairment of the sense of responding as a person and to increase the satisfaction level of the customer who uses the manned chat.

(2) In the response time management program, the operator accesses the information source 200, 300, 350 for obtaining answer information to be sent to the user terminal 500, creates answer information based on the original answer which is information obtained from the information source 200, 300, 350, and further, in a case where it is detected that the operator who has obtained the original answer has performed an operation for obtaining further information, the operator causes the computer 100 to send, to the user terminal 500, message information notifying the customer that preparation for sending the answer information is in progress.

According to this, in a case where it takes time to prepare to send out the answer information, it is possible to suppress a situation in which the customer misunderstands that the waiting time is long and the chatbot session is interrupted and leaves the session, or a situation in which the customer is annoyed by a long silence, and it is possible to increase the satisfaction level of the customer.

(3) In the response time management program, the computer is further caused to execute, when it is detected that the elapsed time has reached the reference response time before the answer information is sent to the user terminal 500, sending, to the user terminal 500, message information notifying the customer that preparation for sending the answer information is in progress.

According to this, even in a case where it takes time to prepare to send out the answer information and the waiting time becomes long, it is possible to suppress a situation in which the customer misunderstands that the waiting time is long and the chatbot session is interrupted and leaves the session, or a situation in which the customer is annoyed by a long silence, and it is possible to increase the satisfaction level of the customer.

(4) In the response time management program, the determining of the reference response time includes estimating the answer information amount based on the question information sent from the user terminal 500 to the operator terminal 10.

According to this, in a case where it takes time to prepare to send out the answer information, it is possible to notify the customer of the estimated time until the answer information is sent out. Therefore, it is possible to suppress a situation in which the customer misunderstands that the waiting time is long and the chatbot session is interrupted and leaves the session, or a situation in which the customer is annoyed by a long silence, and it is possible to increase the satisfaction level of the customer.

(5) In the response time management program, the computer 100 is further caused to execute acquiring answer rapidity preference information capable of specifying the customer's preference with respect to the length of the waiting time until the answer information is sent from the operator terminal 10 after the customer performs the operation of sending the question information, and adjusting the reference response time based on the answer rapidity preference information.

According to this, it is possible to adjust the sending timing of the answer information according to the preference of the customer regarding the waiting time, for example, whether preference is given to an answer in a relatively short time or preference is given to slow interaction, and it is possible to respond with less stress according to the customer's personality.

(6) A response time management apparatus manages a time until the operator accesses the information source to obtain answer information corresponding to the question information in response to the question information sent by the customer operating the user terminal 500 from the user terminal 500 (FIG. 2) operated by the customer being received by the operator terminal 10 operated by the operator, creates the answer information based on the original answer which is the information obtained from the information source 200, 300, 350, and performs an operation of sending the answer information from the operator terminal 10 to the user terminal 500. The response time management apparatus includes an elapsed time measurement unit 118 serving as an elapsed time detection unit that detects an elapsed time from when the operator terminal 10 receives the question information from the user terminal 500 to when the answer information is sent to the user terminal 500, a reference response time determination unit 114 that determines a reference response time which is a reference value of time from when the operator terminal 10 receives the question information from the user terminal 500 to when the answer information is sent to the user terminal 500 based on the answer information amount which is an information amount of the answer information sent from the operator terminal 10 to the user terminal 500, and an answer information sending unit 120 that, when it is detected that the operator has performed an operation of sending the answer information to the user terminal 500 before the elapsed time reaches the reference response time, temporarily suspends sending the answer information to the user terminal 500 and sends the answer information after the reference response time has been reached.

According to this, when the customer obtains the answer information from the operator through the manned chat, the response is performed in the response time corresponding to the information amount of the answer information, so that it is possible to suppress impairment of the sense of responding as a person and to increase the satisfaction level of the customer who uses the manned chat.

(7) A manned chat system includes a user terminal 500 that is operated by a customer (FIG. 2), an operator terminal 10 that is operated by an operator, and a response time management apparatus 100 that manages a time until the operator accesses the information source 200, 300, 350 to obtain answer information corresponding to the question information in response to the question information sent by the customer operating the user terminal 500 from the user terminal 500 being received by the operator terminal 10, creates the answer information based on the original answer which is the information obtained from the information source 200, 300, 350, and sends the answer information from the operator terminal 10 to the user terminal 500. The response time management apparatus 100 includes an elapsed time measurement unit 118 serving as an elapsed time detection unit that detects an elapsed time from when the operator terminal 10 receives the question information from the user terminal 500 to when the answer information is sent to the user terminal 500, a reference response time determination unit 114 that determines a reference response time which is a reference value of time from when the operator terminal 10 receives the question information from the user terminal 500 to when the answer information is sent to the user terminal 500 based on the answer information amount which is an information amount of the answer information sent from the operator terminal 10 to the user terminal 500, and an answer information sending unit 120 that, when it is detected that the operator has performed an operation of sending the answer information to the user terminal 500 before the elapsed time reaches the reference response time, temporarily suspends sending the answer information and sends the answer information after the reference response time has been reached.

According to this, when the customer obtains the answer information from the operator through the manned chat, the response is performed in the response time corresponding to the information amount of the answer information, so that it is possible to suppress impairment of the sense of responding as a person and to increase the satisfaction level of the customer who uses the manned chat.

The above embodiment can be combined as desired with one or more of the aforesaid modifications. The modifications can also be combined with one another.

According to the present disclosure, when the customer obtains the answer information from the operator through the manned chat, the response is performed in the response time corresponding to the information amount of the answer information, so that it is possible to suppress impairment of the sense of responding as a person and to increase the satisfaction level of the customer who uses the manned chat.

Above, while the present invention has been described with reference to the preferred embodiments thereof, it will be understood, by those skilled in the art, that various changes and modifications may be made thereto without departing from the scope of the appended claims.

What is claimed is:

1. A computer-readable storage medium storing a response time management program for causing a computer comprising a processor and a storage unit to perform processing, wherein
the response time management program is configured to manage a time from when question information sent by a customer operating a user terminal is received at an operator terminal operated by an operator, until the operator accesses an information source to obtain answer information corresponding to the question information, creates the answer information based on an original answer, and performs an operation to send the answer information from the operator terminal to the user terminal,
the original answer is information obtained from the information source, and
the response time management program causes the computer to perform:
detecting an elapsed time from when the operator terminal receives the question information from the user terminal until the answer information is sent to the user terminal;
determining a reference response time based on an answer information amount, the answer information amount being an information amount of the answer information sent from the operator terminal to the user terminal, the reference response time being a reference value of a time from when the operator terminal receives the question information from the user terminal until the answer information is sent to the user terminal; and
when it is detected that the operator has performed an operation to send the answer information to the user terminal before the elapsed time reaches the reference response time, temporarily holding a sending of the answer information, and sending the answer information after the reference response time is reached.

2. The storage medium according to claim 1, wherein
the response time management program further causes the computer to perform:
sending message information to the user terminal informing the customer that preparation for sending the answer information is in progress, when it is detected that the operator who obtained the original answer has performed an operation to obtain further information.

3. The storage medium according to claim 1, wherein
the response time management program further causes the computer to perform:
sending message information to the user terminal informing the customer that preparation for sending the answer information is in progress, when it is detected that the elapsed time has reached the reference response time before the answer information is sent to the user terminal.

4. The storage medium according to claim 1, wherein
the response time management program causes the computer to perform:
the determining including estimating the answer information amount based on the question information sent from the user terminal to the operator terminal.

5. The storage medium according to claim 1, wherein
the response time management program further causes the computer to perform:
acquiring answer promptness preference information capable of identifying a preference of the customer for the length of waiting time from when the customer performs an operation to send the question information until the answer information is sent from the operator terminal; and
adjusting the reference response time based on the answer promptness preference information.

6. A response time management apparatus configured to manage a time from when question information sent by a customer operating a user terminal is received at an operator terminal operated by an operator, until the operator accesses an information source to obtain answer information corresponding to the question information, creates the answer information based on an original answer, and performs an operation to send the answer information from the operator terminal to the user terminal, the original answer being information obtained from the information source, the response time management apparatus comprising a microprocessor and a memory connected to the microprocessor, wherein
the microprocessor is configured to perform:
detecting an elapsed time from when the operator terminal receives the question information from the user terminal until the answer information is sent to the user terminal;
determining a reference response time that is a reference value of the time from when the operator terminal receives the question information from the user terminal until the answer information is sent to the user terminal, based on an answer information amount that is an information amount of the answer information sent from the operator terminal to the user terminal; and
when it is detected that the operator has performed an operation to send the answer information to the user terminal before the elapsed time reaches the reference response time, temporarily holding the sending of the answer information to the user terminal, and sending the answer information after the reference response time is reached.

7. A chat system comprising:
a user terminal operated by a customer;
an operator terminal operated by an operator; and
a response time management apparatus configured to manage a time from when question information sent by the customer operating the user terminal is received at the operator terminal, until the operator accesses an information source to obtain answer information corresponding to the question information, creates the answer information based on an original answer, and sends the answer information from the operator terminal to the user terminal, wherein
the original answer is information obtained from the information source,
the response time management apparatus comprises a microprocessor and a memory connected to the microprocessor, and
the microprocessor is configured to perform:
detecting an elapsed time from when the operator terminal receives the question information from the user terminal until the answer information is sent to the user terminal;
determining a reference response time that is a reference value of the time from when the operator terminal receives the question information from the user terminal until the answer information is sent to the user terminal, based on an answer information amount that is an information amount of the answer information sent from the operator terminal to the user terminal; and
when it is detected that the operator has performed an operation to send the answer information to the user terminal before the elapsed time reaches the reference response time, temporarily holding the sending of the answer information, and sending the answer information after the reference response time is reached.
